(19) United States
(12) Patent Application Publication
(10) Pub. No.: US 2014/0198515 A1
(43) Pub. Date: Jul. 17, 2014

(54) VEHICLE EXTERIOR MIRROR AND LIGHT ASSEMBLIES

(71) Applicant: FORD GLOBAL TECHNOLOGIES, LLC, Dearbrn, MI (US)

(72) Inventors: Pamela J. Tulio, Southgate, MI (US); Michael Kevin Martin, Livonia, MI (US); David Burgess, Canton, MI (US); Gregory Czinder, Newaygo, MI (US); Darrell Commans, Newaygo, MI (US); Gregory Huizen, Newaygo, MI (US); Douglas Wilson, Fort Gratiot, MI (US); Nicholas Schmidt, Marysville, MI (US)

(73) Assignee: FORD GLOBAL TECHNOLOGIES, LLC, Dearborn, MI (US)

(21) Appl. No.: 13/739,605

(22) Filed: Jan. 11, 2013

(51) Int. Cl. B60Q 1/00

(52) U.S. Cl. CPC B60Q 1/0035
USPC 362/516; 362/544; 362/520

(57) ABSTRACT

A vehicle mirror assembly is provided with a housing adapted to be mounted to a vehicle exterior. A mirror is mounted in the housing. A plurality of light assemblies is oriented upon the housing for collectively illuminating a thoroughfare adjacent to the vehicle exterior. A vehicle is also provided with a vehicle body with an exterior. The vehicle mirror assembly is mounted to the vehicle exterior.

### TECHNICAL FIELD

Various embodiments relate to vehicle exterior mirror assemblies and vehicle exterior light assemblies.

### BACKGROUND

The prior art has offered independent spot lights, usually mounted on the door, which are often utilized by law enforcement. Recreation and hobbyists often employ spotlights on top of a vehicle cab or upon a front vehicle bumper.

### SUMMARY

According to at least one embodiment, a vehicle mirror assembly is provided with a housing adapted to be mounted to a vehicle exterior. A mirror is mounted in the housing. A plurality of light assemblies is oriented upon the housing for collectively illuminating a thoroughfare adjacent to the vehicle exterior.

According to a further embodiment, the plurality of light assemblies is further provided with a plurality of spotlights.

According to an even further embodiment, the plurality of light assemblies is further provided with a plurality of signal indicators.

According to another even further embodiment, the plurality of light assemblies is further provided with a plurality of reflectors, and a plurality of light sources.

According to an even further embodiment, each of the plurality of light sources is further provided with a light emitting diode (LED).

According to an even further embodiment, each of the plurality of light assemblies is further provided with a printed circuit board (PCB), wherein each LED is mounted on one of the plurality of PCBs.

According to an even further embodiment, the vehicle mirror assembly is further provided with a plurality of signal indicators, each mounted to one of the PCBs.

According to another further embodiment, the plurality of light assemblies illuminates a region from the plurality of light assemblies to at least nine feet away from the plurality of light assemblies.

According to another further embodiment, at least two of the plurality of light assemblies are oriented nonparallel to each other.

According to an even further embodiment, the at least two of the plurality of light assemblies each illuminate a region from the plurality of light assemblies to at least nine feet away from the plurality of light assemblies.

According to another further embodiment, at least one of the plurality of light assemblies is oriented facing a forward direction of the vehicle exterior. At least one of the plurality of light assemblies is oriented facing a rearward direction of the exterior.

According to another further embodiment, the light assembly is further provided with a lens cover with a fluted interior.

According to at least one embodiment, a vehicle is provided with a vehicle body with an exterior. A mirror housing is mounted to the vehicle exterior. A plurality of light assemblies is oriented upon the housing for collectively illuminating a thoroughfare adjacent to the vehicle exterior.

According to a further embodiment, the vehicle is further provided with a power source, a switch, and a controller in communication with the power source, the switch and the plurality of light assemblies to power and consequently illuminate the light assemblies when the switch is actuated.

According to an even further embodiment, the mirror housing is pivotally connected to the vehicle body and the controller is configured to operate the plurality of light assemblies independent of a pivotal orientation of the mirror housing relative to the vehicle body.

According to another even further embodiment, the vehicle is further provided with a receiver in communication with the controller, wherein the controller is configured to power and consequently illuminate the plurality of light assemblies upon receipt of input indicative of a signal transmitted from a key fob associated with the vehicle.

According to another further embodiment, the plurality of light assemblies is further provided with a plurality of spotlights.

According to an even further embodiment, the vehicle is further provided with a power source, a switch, and a controller in communication with the power source, the switch and the plurality of light assemblies to power and consequently illuminate the light assemblies when the switch is actuated.

According to an even further embodiment, the plurality of light assemblies is further provided with a plurality of signal indicators.

According to an even further embodiment, the vehicle is further provided with a steering column stalk switch in communication with the controller, wherein the controller is configured to convey power to, and consequently illuminate the plurality of signal indicators when the switch is actuated.

### BRIEF DESCRIPTION OF THE DRAWINGS

FIG. 1 is a side perspective view of a vehicle with a mirror assembly according to an embodiment with a plurality of light assemblies illustrated schematically as illuminated for depicting an illumination zone;

FIG. 2 is top perspective view of the vehicle and the illumination zone of FIG. 1;

FIG. 3 is a front side perspective view of the vehicle and the illumination zone of FIG. 1;

FIG. 4 is a front perspective view of the plurality of light assemblies of FIG. 1;

FIG. 5 is an exploded perspective view of the plurality of light assemblies of FIG. 1;

FIG. 6 is a side perspective view of a vehicle with a mirror assembly according to another embodiment with a plurality of light assemblies illustrated schematically as illuminated for depicting an illumination zone;

FIG. 7 is top perspective view of the vehicle and the illumination zone of FIG. 6;

FIG. 8 is a front side perspective view of the vehicle and the illumination zone of FIG. 6;

FIG. 9 is front side perspective view of a mirror assembly according to another embodiment;

FIG. 9A is a partial section view taken along section line A-A in FIG. 9; and

FIG. 10 is another front side perspective view of the mirror assembly of FIG. 9 illustrated partially disassembled.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

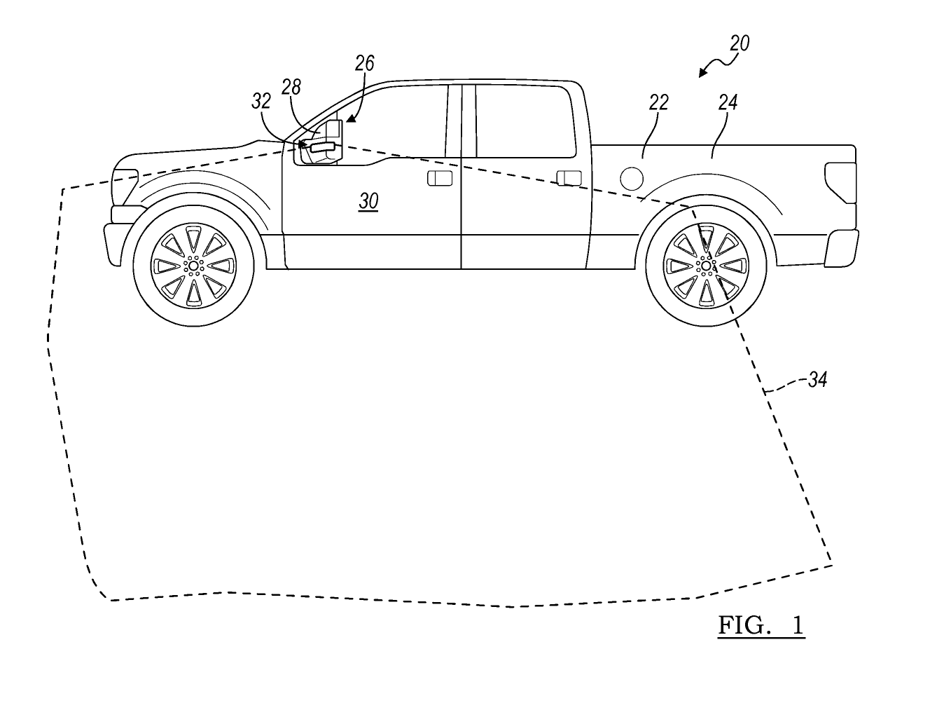

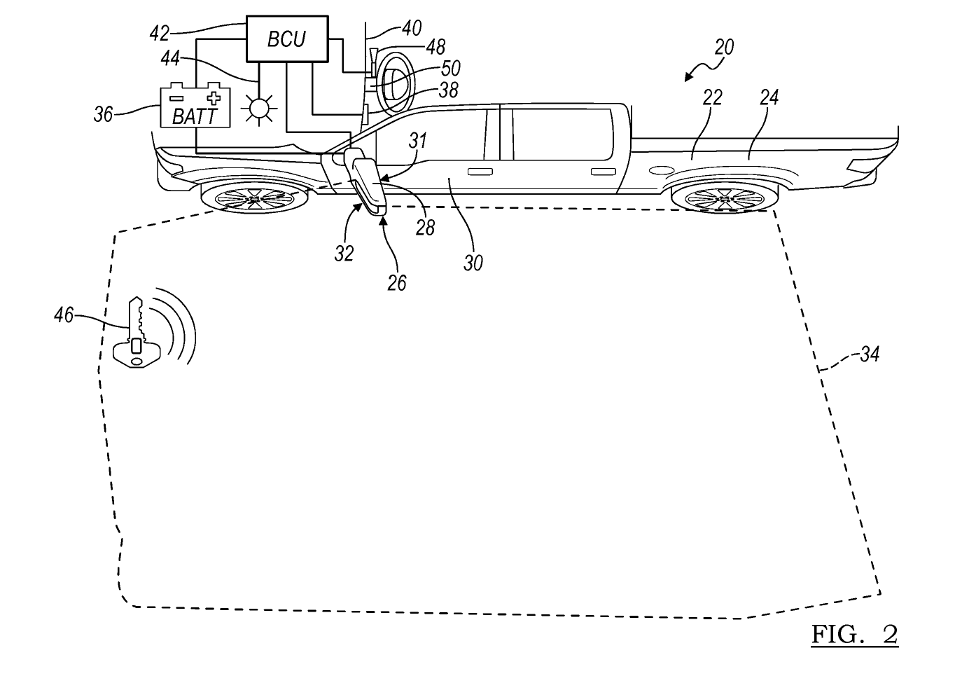

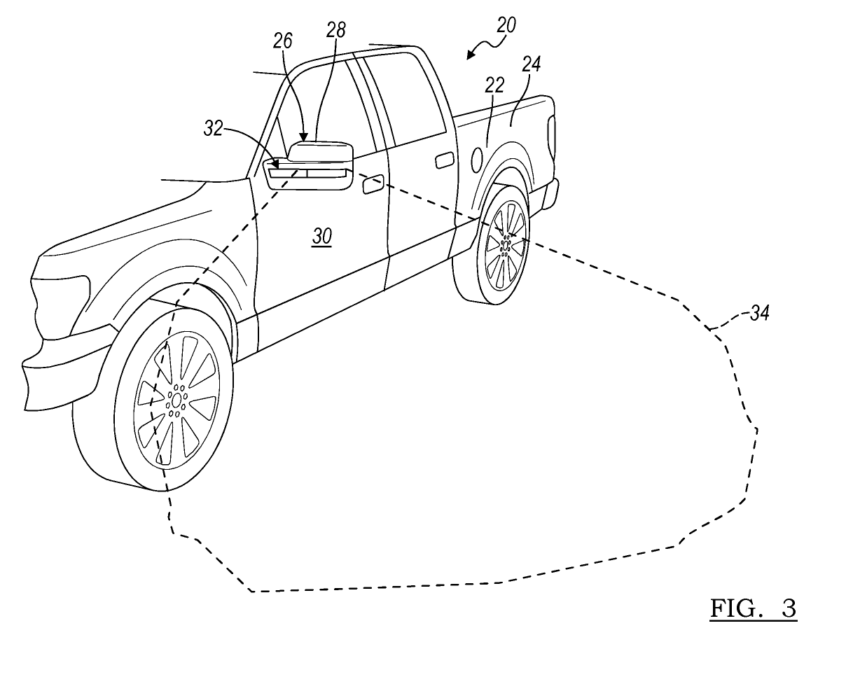

With reference to FIGS. 1-3, a vehicle is illustrated according to an embodiment and is referenced generally by numeral 20. The vehicle 20 includes a vehicle body 22 with an exterior 24 as depicted. A sideview mirror assembly 26 includes a housing 28 mounted to the vehicle body 22, for example, to a vehicle door 30. The mirror assembly 26 includes a sideview mirror 31 (FIG. 2) for assisting a driver in viewing a reflected region upon the mirror 31. The mirror assembly 26 includes a plurality of light assemblies 32 such as spotlights, oriented upon the housing 28 for collectively illuminating a thoroughfare adjacent to the vehicle exterior 24. An illumination zone 34 provided by the light assemblies 32 is depicted in FIGS. 1-3. The illumination zone 34 may be utilized in absence of ambient light, which may be beneficial for performing work or maintenance outside the vehicle 20.

Referring specifically to FIG. 2, the vehicle 20 includes a power source such as a battery 36 for powering the light assemblies 32. A switch 38 is mounted on a dashboard 40 of the vehicle 20. A controller 42 such as a body control unit is mounted to the vehicle in communication with the battery 36, the switch 38 and the plurality of light assemblies 32 for illuminating the plurality of light assemblies when the switch 38 is manually actuated. Therefore the illumination zone 34 is manually controlled. The controller 42 may be configured to prevent illumination of the zone 34 during travel of the vehicle to prevent inadvertent illumination and to conserve energy.

The mirror assembly 26 may be retractable, as is known in the art, to pivot towards the vehicle door 30 as depicted by the arrow in FIG. 2. The operation of the light assemblies 32 may be configured to be independent of the position of the mirror assembly 26 to permit the user to adjust the illumination zone 34 and/or permit the user to utilize the illumination zone 34 even when retraction of the mirror assembly 26 may be desired.

The vehicle 20 may also include a receiver 44 in communication with the controller 42. The controller 42 may be configured to power and consequently illuminate the plurality of light assemblies 32 upon receipt of input indicative of a signal transmitted from a key fob 46 associated with the vehicle 20. Therefore, the operation of the light assemblies 32 may be controlled from the key fob 46 of the user.

The plurality of light assemblies 32 may also include signal indicators, such as amber light sources to visually communicate to other drivers an intention to turn. Accordingly, a stalk switch 48 may be provided on a steering column 50 of the vehicle 20. The stalk switch 48 is in communication with the controller 42 such that actuation of the stalk switch 48 results in intermittent illumination of the signal indicators of the plurality of light assemblies 32.

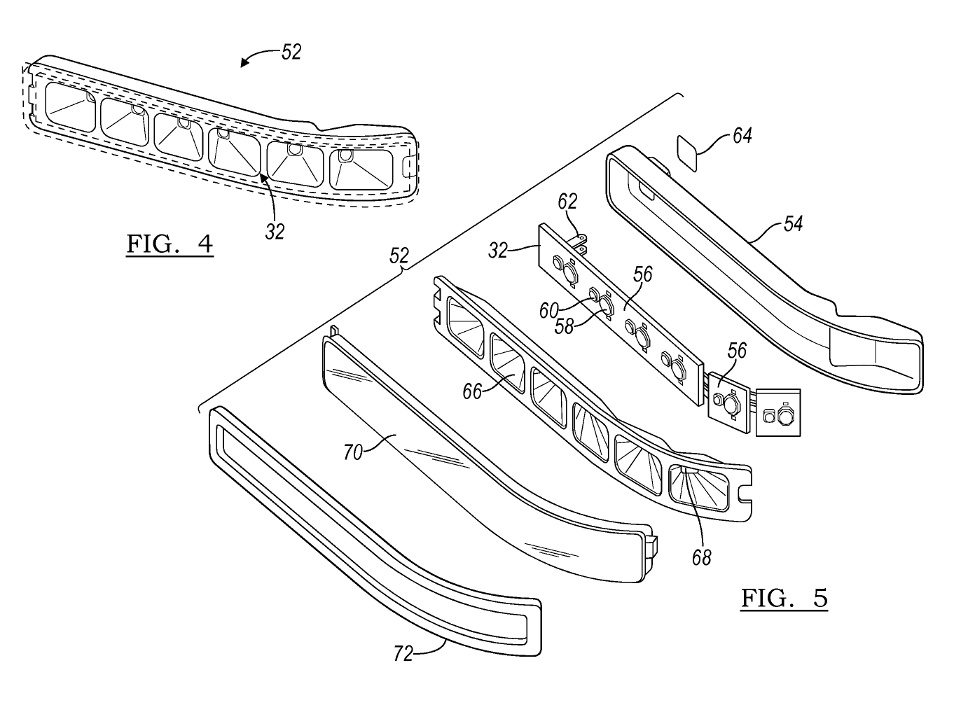

Referring now to FIGS. 4 and 5, a lighting subassembly 52 is illustrated according to at least one embodiment. The lighting subassembly 52 includes a rear housing 54 for being fastened to the mirror housing 28. The rear housing 54 supports a plurality of printed circuit boards (PCBs) 56 each oriented along the rear housing 54. Each PCB 56 includes a spotlight, which is provided by a light emitting diode (LED) 58. Each PCB 56 also includes a signal indicator LED 60. A power terminal 62 is provided on the plurality of PCBs 56 for passing through a seal 64 for electrical connection with a corresponding receptacle within the mirror assembly 26.

A plurality of reflectors 66 are provided on the rear housing 54 with the PCBs 56 therebetween. The reflectors 66 may be formed integrally as depicted and each include an aperture 68 aligned with the corresponding LEDs 58, 60. The reflectors 66 are utilized for reflecting and redirecting incidental light rays from the LEDs 58, 60 for focusing the illumination to a targeted thoroughfare. The reflectors 66 and corresponding LEDs 58, 60 are oriented to convey light forward, laterally outboard, and rearward of the mirror assembly 26 with respect to the vehicle 20 for illuminating the expanded illumination zone 34 and for conveying a turn signal to viewers in various directions with respect to the vehicle. Each spotlight LED 58 may illuminate a region of up to ten feet, and at least nine feet, for collectively providing the enlarged illumination zone 34 depicted in FIGS. 1-3. Rearward facing spotlight LEDs 58 can be controlled and operated separately for providing clearance illumination rearward of the mirror assembly 26 for assistance in trailering and towing operations.

A translucent lens cover 70 and a gasket 72 are also provided in the lighting subassembly 52 for isolating the light assemblies 32 from external contaminants and weather.

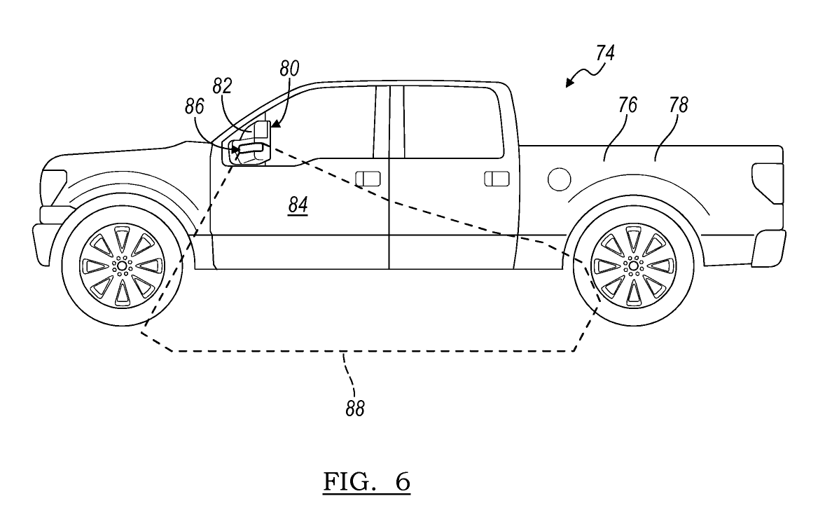

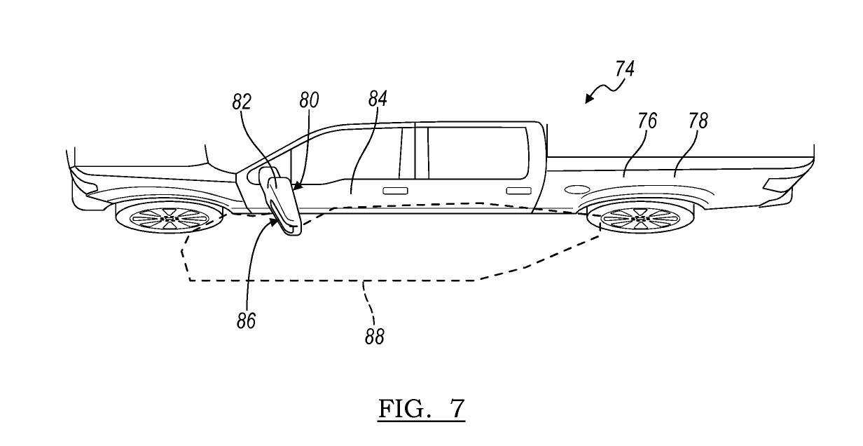

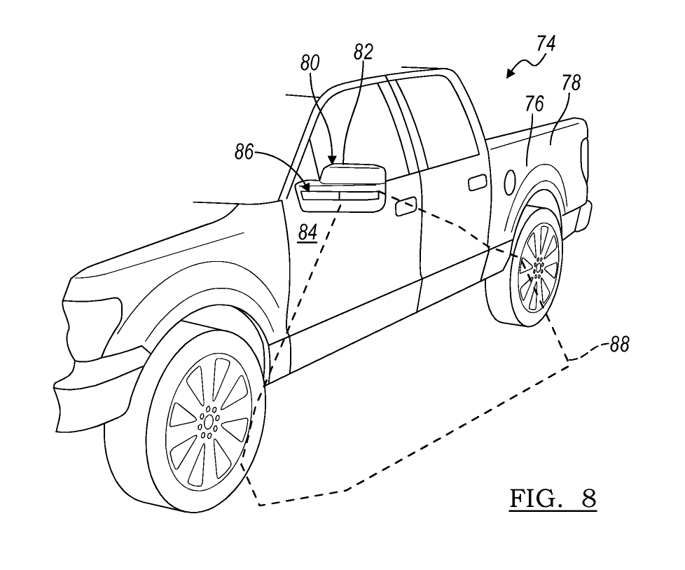

FIGS. 6-8 illustrate a vehicle 74 according to another embodiment. The vehicle 74 includes a vehicle body 76 with an exterior 78. A mirror assembly 80 includes a housing 82 mounted to a door 84 of the vehicle body 76. A plurality of light assemblies 86 are provided on the housing 82. The light assemblies 86 employ a lower quantity of light assemblies 86 than the prior embodiment for generating a reduced illumination zone 88 in comparison to the prior embodiment, while requiring less energy than the prior embodiment. Accordingly, various illumination zones 34, 88 are obtainable within the scope of the present invention, which may be configured under the teachings of the disclosure with routine experimentation by a person having ordinary skill in the art.

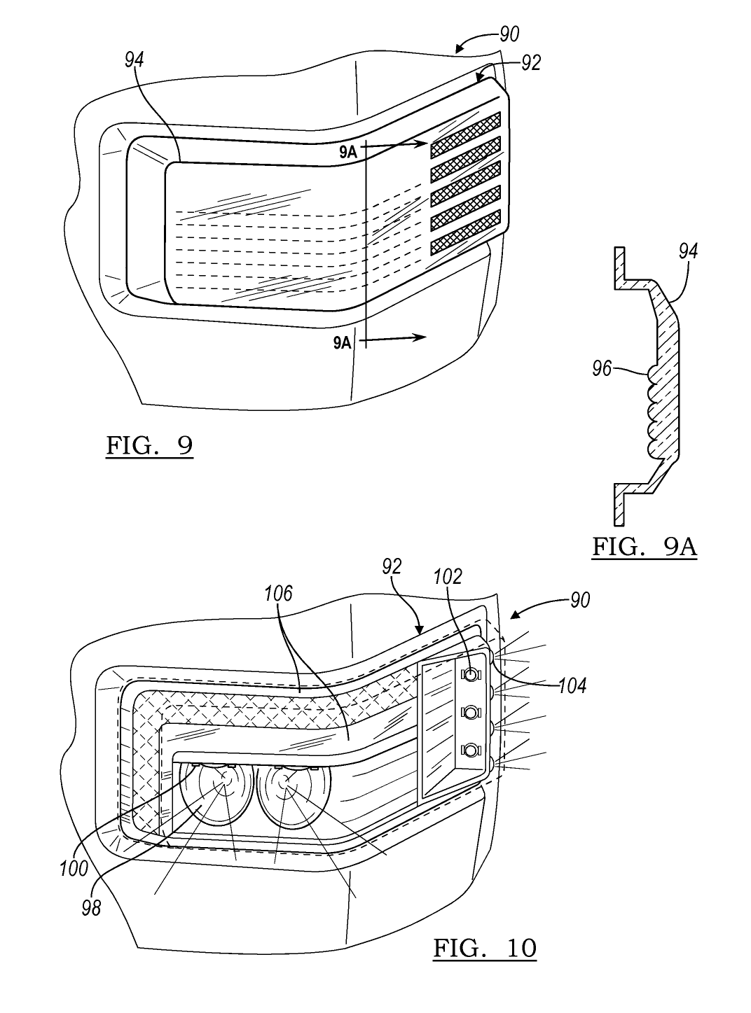

FIGS. 9 and 10 illustrate a mirror assembly 90 according to another embodiment. A lighting subassembly 92 includes a lens cover 94 which has a fluted interior 96 as depicted in FIG. 9A for refracting light through the lens cover 94 to provide a desired illumination effect, which may be diffused to by the fluted interior 96 to minimize harsh lighting to a user. FIG. 10 illustrates the lighting subassembly 92 with the lens cover 94 removed to illustrate yet another embodiment configuration of reflectors 98 for glare reduction. LEDs may be directed downward 100 at the reflectors 100; forward 102 for clearance; and rearward 104 for compliance. A light pipe 106 with an etched surface may also be employed and illuminated by another light assembly for providing an illuminated surface as is known in the art.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle mirror assembly comprising:
a housing adapted to be mounted to a vehicle exterior;
a mirror mounted in the housing; and
a plurality of light assemblies oriented upon the housing for collectively illuminating a thoroughfare adjacent to the vehicle exterior.

2. The vehicle mirror assembly of claim 1 wherein the plurality of light assemblies further comprises a plurality of spotlights.

3. The vehicle mirror assembly of claim 2 wherein the plurality of light assemblies further comprises a plurality of signal indicators.

4. The vehicle mirror assembly of claim 2 wherein the plurality of light assemblies further comprises:
a plurality of reflectors; and
a plurality of light sources.

5. The vehicle mirror assembly of claim 4 wherein each of the plurality of light sources further comprises a light emitting diode (LED).

6. The vehicle mirror assembly of claim 5 wherein each of the plurality of light assemblies further comprises a printed circuit board (PCB), wherein each LED is mounted on one of the plurality of PCBs.

7. The vehicle mirror assembly of claim 6 further comprising a plurality of signal indicators, each mounted to one of the PCBs.

8. The vehicle mirror assembly of claim 1 wherein the plurality of light assemblies illuminates a region from the plurality of light assemblies to at least nine feet away from the plurality of light assemblies.

9. The vehicle mirror assembly of claim 1 wherein at least two of the plurality of light assemblies are oriented nonparallel to each other.

10. The vehicle mirror assembly of claim 9 wherein the at least two of the plurality of light assemblies each illuminate a region from the plurality of light assemblies to at least nine feet away from the plurality of light assemblies.

11. The vehicle mirror assembly of claim 1 wherein at least one of the plurality of light assemblies is oriented facing a forward direction of the vehicle exterior; and
wherein at least one of the plurality of light assemblies is oriented facing a rearward direction of the exterior.

12. The vehicle mirror assembly of claim 1 wherein the light assembly further comprises a lens cover with a fluted interior.

13. A vehicle comprising:
a vehicle body with an exterior;
a mirror housing mounted to the vehicle exterior; and
a plurality of light assemblies oriented upon the housing for collectively illuminating a thoroughfare adjacent to the vehicle exterior.

14. The vehicle of claim 13 further comprising:
a power source;
a switch; and
a controller in communication with the power source, the switch and the plurality of light assemblies to power and consequently illuminate the light assemblies when the switch is actuated.

15. The vehicle of claim 14 wherein the mirror housing is pivotally connected to the vehicle body and the controller is configured to operate the plurality of light assemblies independent of a pivotal orientation of the mirror housing relative to the vehicle body.

16. The vehicle of claim 14 further comprising a receiver in communication with the controller, wherein the controller is configured to power and consequently illuminate the plurality of light assemblies upon receipt of input indicative of a signal transmitted from a key fob associated with the vehicle.

17. The vehicle of claim 13 wherein the plurality of light assemblies further comprises a plurality of spotlights.

18. The vehicle of claim 17 further comprising:
a power source;
a switch; and
a controller in communication with the power source, the switch and the plurality of light assemblies to power and consequently illuminate the light assemblies when the switch is actuated.

19. The vehicle of claim 18 wherein the plurality of light assemblies further comprises a plurality of signal indicators.

20. The vehicle of claim 19 further comprising a steering column stalk switch in communication with the controller, wherein the controller is configured to convey power to, and consequently illuminate the plurality of signal indicators when the switch is actuated.
